(19) United States
(12) Patent Application Publication
(10) Pub. No.: US 2006/0040627 A1
(43) Pub. Date: Feb. 23, 2006

(54) Fm receiver, noise eliminating apparatus of fm receiver, and noise eliminating method thereof

(75) Inventors: Tsuyoshi Koike, Kariya-shi (JP); Hiroshi Miyagi, Joetsu-shi (JP)

Correspondence Address: MORGAN & FINNEGAN, L.L.P., 3 WORLD FINANCIAL CENTER, NEW YORK, NY, 10281-2101, US

(73) Assignees: Kabushiki Kaisha Toyota Jidoshokki, Kariya-shi (JP); Niigata Seimitsu Co., Ltd., Joetsu-shi (JP)

(21) Appl. No.: 10/530,019

(22) PCT Filed: Oct. 1, 2003
(86) PCT No.: PCT/JP03/12614

§ 371 Date: Apr. 1, 2005

(30) Foreign Application Priority Data
Oct. 3, 2002 (JP) 2002-290897

(51) Int. Cl. H04B 1/16

(52) U.S. Cl. 455/210; 455/205

(57) ABSTRACT

The present invention prevents sound quality from degrading due to a change in electric field intensity or due to multi-path noise. An arithmetic unit subtracts a signal based on the detection signal of multi-path noise whose time constant is specified by a second time constant circuit from a signal based on an RSSI signal whose time constant is specified by a first time constant. An output signal from this arithmetic unit is applied, as a control signal, to a stereo-noise control circuit or the like. This can control the degradation of separation and the like in accordance with multi-path fading to prevent sound quality from degrading.

### TECHNICAL FIELD

The present invention relates to a technology for eliminating noise from receivers, and more particularly to a technology for eliminating multi-path noise from FM receivers.

### BACKGROUND ART

A factor for incurring a receiving failure in an FM receiver includes fading in which an FM radio wave propagation route fluctuates when a receiver moves or when radio waves are absorbed or reflected even if the receiver is fixed and as a result, receiving electric field intensity change, so-called “multi-path fading”. In this specification, signal distortion due to this multi-path fading is called “multi-path noise”.

As an FM receiver taking this multi-path noise into consideration, there is an FM receiver disclosed by Patent Reference 1. In this FM receiver, capacitors C11 and C12 for determining a time constant are provided in parallel. When usually receiving broadcast, this multi-path noise is coped with by degrading channel separation using a time constant specified by the capacitor C11. When a receiving mode is switched, time when a high frequency signal generated due to receiving mode switching or the like degrades channel separation is shortened by reducing a time constant by switching the capacitor 11 to the capacitor C12 of small capacity. Patent Reference 1:

Japanese Patent Application No. H6-140946 (FIG. 1, pp. 2-3)

It is an object of the present invention to provide an FM receiver, a noise eliminator for the FM receiver and a noise elimination method.

### DISCLOSURE OF INVENTION

In order to attain the object, the FM receiver of the present invention comprises a first detection means, a first time constant setting means, a second detection means, a second time constant setting means, an arithmetic means and a control means.

The first detection means outputs an RSSI signal indicating the intensity of a received radio wave.

The first time constant setting means sets a first time constant in the RSSI signal.

The second detection means outputs a detection signal corresponding to a high frequency component due to, for example, multi-path noise included in an IF signal.

The second time constant setting means sets a second time constant in the detection signal outputted by the second detection means.

The arithmetic means outputs a signal obtained by subtracting a signal based on the detection signal from a signal based on the RSSI signal.

The control means controls at least one of a stereo-noise control circuit, a high-cut control circuit and a muting circuit.

The present invention can also be realized as a noise eliminator for FM receivers comprising the first detection means, the first time constant setting means, the second detection means, the second time constant setting means and the arithmetic means or a noise elimination method thereof.

According to the present invention, usually the control signal change based on the RSSI signal with the first time constant, and for example, when a high frequency component occurs due to multi-path noise, the control signal change based on the detection signal with the second time constant. Thus, by using this control signal, a control signal in which two time constants are switched can be realized. In this case, no time delay also occurs due to this time constant switching.

### BRIEF DESCRIPTION OF DRAWINGS

FIG. 1 is a block diagram showing the configuration of the multi-path noise detection part of the FM receiver of one preferred embodiment of the present invention.

### BEST MODE FOR CARRYING OUT THE INVENTION

One preferred embodiment of the present invention is described below with reference to the drawings.

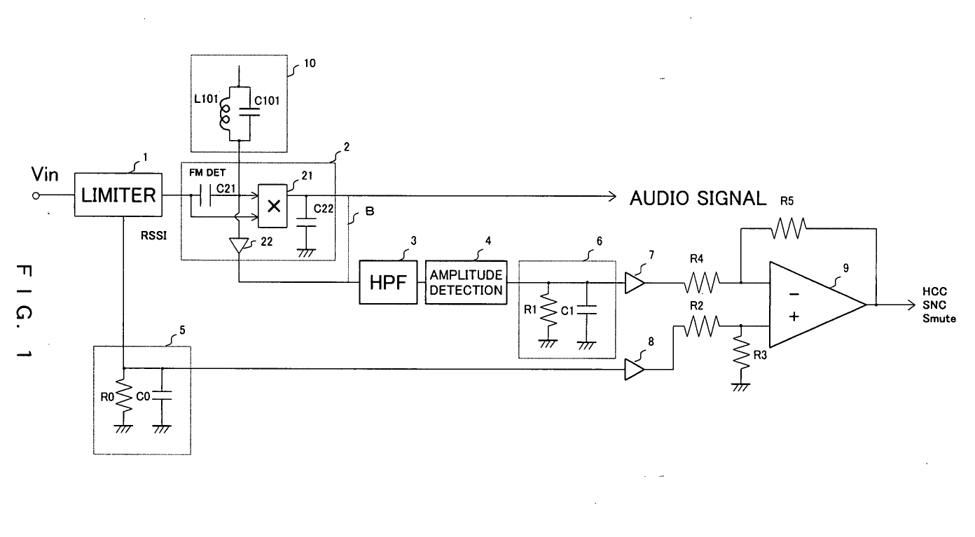

FIG. 1 is a block diagram showing the configuration of the multi-path noise detection part of the FM receiver of this preferred embodiment. In FIG. 1, the output of an IF amplifier is inputted as a signal Vin, and multi-path noise is detected.

The FM receiver of this preferred embodiment has a configuration for detecting the electric field intensity of a received wave using a received signal strength indicator (RSSI) and a configuration for detecting multi-path noise, and a signal obtained by subtracting the detection signal of the multi-path noise from a signal indicating electric field intensity is used as a control signal to a stereo-noise control circuit and the like.

The configuration shown in FIG. 1 comprises a limiter 1, an FM detector (FM DET) 2, a high-pass filter (HPF) 3, an amplitude detector 4, two time constant circuits 5 and 6, two amplifiers 7 and 8, an arithmetic unit 9, a tuning circuit 10 and resistors R2-R5.

The limiter 1 is provided before the FM detector 2, and eliminates the amplitude fluctuation of signals prior to the FM detection by the FM detector 2. The limiter 1 shown in FIG. 1 outputs an RSSI signal, which indicates the change in intensity of an output signal from the IF amplifier as the change of voltage, and has a voltage corresponding to the intensity of a received wave, in addition to a signal that limits amplitude.

The FM detector 2 demodulates IF an signal to output an audio signal. The FM detector 2 also outputs a signal for detecting multi-path noise, separately from the audio signal.

The FM detector 2 is a quadrature detector. The FM detector 2 outputs audio signals by multiplying an IF signal by a signal obtained by shifting the phase of this IF signal by 90 degrees by a phase-shifted capacitor C21 and eliminating a component having a frequency signal which is the sum of frequency of an FM signal wave and the phase-shifted signal from this signal, by the capacitor C22 which acts as low-pass filter. The phase-shifted signal outputted from the capacitor C21 is amplified by the amplifier 22, and high-frequency components of 100 kHz or more are extracted by the high-pass filter 3.

The high-pass filter 3 is a high-pass filter whose pass band is the frequency of multi-path noise. The high-pass filter 3 extracts multi-path noise by extracting high frequency components of 100 kHz or more from the multi-path noise detecting signal outputted from the FM detector 2.

The amplitude detector 4 outputs high DC voltage according to the amplitude of an input signal.

The time constant circuit 5 sets the time constant of an RSSI signal inputted to the arithmetic unit 9, and comprises a resistor R0 and a capacitor C0. The time constant circuit 6 sets the time constant of the multi-path detecting signal inputted to the arithmetic unit 9, and comprises a resistor R1 and a capacitor C1. This time constant circuit 6 extracts signals of frequencies, for example, 400-500 KHz or more (including an intermediate frequency signal of 10.7 MHz), and the capacitor C1 of the time constant circuit 6 is charged by voltage corresponding to the size of multi-path noise. The relationship between a time constant t0 (=R0·C0) set by the time constant circuit 5 and a time constant t1 (=R1·C1) set by the time constant circuit 6 is t0>t1.

The amplifiers 7 and 8 are provided to balance the impedance between the two time constant circuits 5 and 6 provided for two inputs of the arithmetic unit 9, and can be realized, for example, by a voltage follower using an operational amplifier. Since the resistor R0 of the time constant circuit 5 is higher than the resistor R1 of the time constant circuit 6, the amplifiers 7 and 8 absorb an influence due to the difference in impedance between the time constant circuit 5 and 6.

The arithmetic unit 9 acts as a subtraction circuit, and outputs a signal obtained by subtracting a signal obtained by amplifying multi-path noise inputted via the amplifier 7 by an amplification rate specified by the resistors R4 and R5 from a signal obtained by amplifying the RSSI signal inputted via the amplifier 8 by an amplification rate specified by the resistors R2 and R3 to the stereo-noise control circuit as a control signal. The stereo-noise control circuit controls channel selection, based on this control signal. Since the output of this arithmetic unit 9 contains the carrier frequency (10.7 MHz) signal component of the intermediate frequency signal, in order to eliminate this, a low-pass filter must be provided after the arithmetic unit 9. Alternatively, an OP amplifier with a low frequency characteristic must be used for the arithmetic unit 9.

The tuning circuit 10 comprises capacitors C101 and a coil L101, and its resonant frequency is set to the central frequency (10.7 MHz) of the input FM signal.

In the configuration shown in FIG. 1, in a normal state where no multi-path noise is piled on a received wave, the arithmetic unit 9 outputs a control signal proportional to the RSSI signal to the stereo-noise control circuit. However, multi-path occurs and multi-path noise of a high frequency is piled on the received signal, a signal corresponding to the amplitude of this high-frequency noise is inputted to the arithmetic unit 9 via the high-pass filter 3, amplitude detector 4, time constant circuit 6 and amplifier 7. The arithmetic unit 9 outputs a signal obtained by subtracting a signal obtained by amplifying this signal by a specific amplification rate from a signal proportional to the RSSI signal to the stereo-noise control circuit as a control signal. Therefore, usually from the arithmetic unit 9, a control signal with time constant t0, proportional to the intensity of the gradually changing intensity of the received wave is outputted. When multi-path noise occurs, the level of the control signal decreases for a period specified by time constant t1 smaller than time constant t0. Since the level of the control signal decreases for a period specified by time constant t1 when multi-path noise occurs, in the stereo-noise control circuit, separation degrades during the period.

As described above, in the configuration shown in FIG. 1, usually a control signal outputted from the arithmetic unit 9 changes, according to the RSSI signal with time constant t0, and when a high-frequency component occurs due to multi-path noise, the control signal changes according to a detection signal with time constant t1. Therefore, by the stereo-noise control circuit controlling separation using this control signal, a control signal in which two time constants are switched can be realized. In this case, no time delay also occurs due to this time constant switching. Therefore, the degradation of separation or the like can be controlled in accordance with multi-path fading, and accordingly, the degradation of sound quality can be prevented.

The control signal outputted from the arithmetic unit shown in FIG. 1 can be outputted to a high-cut control circuit (HCC) for attenuating a high-band component instead of being outputted to the stereo-noise control circuit to be used only to control multi-separation. Alternatively, the control signal can be outputted to a muting circuit for performing soft mute (S-mute). Alternatively, this control signal can control all of the stereo-noise control circuit, high-cut control circuit and muting circuit. Alternatively, this control signal can control only one or two of these circuits. Furthermore, all of these three or only one or two can also be arbitrarily selected and be switched and controlled as requested.

Although in the configuration shown in FIG. 1, the output of the phase-shifting capacitor C21 of the FM detector is multi-path noise detection signal, it can also be configured as shown by dotted lines B instead of solid lines A in FIG. 1 and audio signal can also be used as the multi-path noise detection signal. In the case of this configuration, since the audio signal contains signals of a broad-band, the frequency characteristic of the high-pass filter 3 must be set more severely than in the case where it is configured as shown by solid lines A. However, if the receiver is provided with a noise canceller, the high-pass filter 3 can also be used as a high-pass filter for the noise canceller.

### INDUSTRIAL APPLICABILITY

According to the present invention, separation degradation and the like can be controlled in accordance with multi-path fading to prevent the degradation of sound quality. In this case, no time delay due to time constant switching also occurs.

1. An FM receiver, comprising:
first detection unit outputting an RSSI signal indicating intensity of a received radio wave;
first time constant setting unit setting a first time constant in the RSSI signal;
second detection unit outputting a detection signal corresponding to a high frequency component included in an IF signal;
second time constant setting unit setting a second time constant in the detection signal outputted by the second detection means;
arithmetic unit outputting a signal obtained by subtracting a signal based on the detection signal from a signal based on the RSSI signal as a control signal; and
control unit controlling at least one of a stereo-noise control circuit, a high-cut control circuit and a muting circuit, according to the control signal.

2. A noise eliminator for an FM receiver, comprising:
first detection unit outputting an RSSI signal indicating intensity of a received radio wave;
first time constant setting unit setting a first time constant in the RSSI signal;
second detection unit outputting a detection signal corresponding to a high frequency component included in an IF signal;
second time constant setting unit setting a second time constant in the detection signal outputted by the second detection means; and
arithmetic unit outputting a signal obtained by subtracting a signal based on the detection signal from a signal based on the RSSI signal as a control signal.

3. The FM receiver or the noise eliminator for the FM receiver according to claim 1, wherein
the first time constant is larger than the second time constant.

4. The FM receiver or the noise eliminator for the FM receiver according to claim 1, wherein
the high frequency component is due to multi-path noise.

5. A noise elimination method for a FM receiver, comprising:
subtracting a second detection signal which has size based on intensity of a high frequency component of an IF signal and has a second time constant from a first detection signal which has size proportional to intensity of an IF signal and has a first time constant, and using a result of the subtraction as a control signal; and
controlling at least one of a stereo-noise control circuit, a high-cut control circuit and a muting circuit, based on the control signal.

6. The noise elimination method according to claim 5, wherein
the high frequency component is due to multi-path noise.

7. An FM receiver comprising:
first detection means for outputting an RSSI signal indicating intensity of a received radio wave;
first time constant setting means for setting a first time constant in the RSSI signal;
second detection means for outputting a detection signal corresponding to a high frequency component included in an IF signal;
second time constant setting means for setting a second time constant in the detection signal outputted by the second detection means;
arithmetic means for outputting a signal obtained by subtracting a signal based on the detection signal from a signal based on the RSSI signal as a control signal; and
control means for controlling at least one of a stereo-noise control circuit, a high-cut control circuit and a muting circuit, according to the control signal.

8. A noise eliminator for an FM receiver comprising:
first detection means for outputting an RSSI signal indicating intensity of a received radio wave;
first time constant setting means for setting a first time constant in the RSSI signal;
second detection means for outputting a detection signal corresponding to a high frequency component included in an IF signal;
second time constant setting means for setting a second time constant in the detection signal outputted by the second detection means; and
arithmetic means for outputting a signal obtained by subtracting a signal based on the detection signal from a signal based on the RSSI signal as a control signal.
